(19) United States
(12) Patent Application Publication
(10) Pub. No.: US 2009/0046208 A1
(43) Pub. Date: Feb. 19, 2009

(54) IMAGE PROCESSING METHOD AND APPARATUS FOR GENERATING INTERMEDIATE FRAME IMAGE

(75) Inventors: Oh-jae KWON, Suwon-si (KR); Jong-sul Min, Hwaseong-si (KR); Ho-seop Lee, Seoul (KR); Hwa-seok Seong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/125,542

(22) Filed: May 22, 2008

(30) Foreign Application Priority Data
Aug. 14, 2007 (KR) 10-2007-0081931

(51) Int. Cl. H04N 5/14

(52) U.S. Cl. 348/700; 348/E05.065

(57) ABSTRACT

Image processing method and apparatus for creating an image of an intermediate frame are provided. The image processing method generates a background image and a first motion image using a current frame and a previous frame, and generates a second motion image of the intermediate frame using either the current frame or the previous frame. Accordingly, it is possible to minimize the interpolation error in the boundary area vulnerable to the motion estimation error.

### CROSS-REFERENCE TO RELATED APPLICATIONS

This application claims priority from Korean Patent Application No. 10-2007-0081931, filed on Aug. 14, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to processing an image, and more particularly, to generating an intermediate frame image and processing an image.

2. Description of the Related Art

The present invention provides an image processing method and apparatus for up-converting a frame through interpolation.

Recently, with technological advances, a variety of image display devices is widely used. In this respect, it is required to provide users with high-quality image signals output from image media.

FIG. 1 depicts an image output according to a conventional image processing method. When a motion vector is estimated using a backward motion vector estimation and the image is moving from the left to the right in the frame as shown in FIG. 1 (that is, when the image comes into the frame from the outside of the frame) the image breakage 10 is caused.

To prevent the image breakage 10, there is an increasing need for a technique to display a more accurate and vivid image in the boundary of the frame.

Particularly, it is required to provide a more vivid image in the boundary of the frame by estimating and interpolating the moving pictures. For the motion estimation, a block matching algorithm is typically used by taking into account accuracy and utility of the motion, real-time processability, and hardware implementation.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image processing method for providing an accurate image in a boundary of a frame by minimizing interpolation error in the boundary of the frame where a motion estimation error is highly likely to occur.

According to an aspect of the present invention, it is provided an image processing method for creating an image of an intermediate frame with respect to a current frame and a previous frame, comprising a first generating operation for generating a background image and a first motion image of the intermediate frame using the current frame and the previous frame; and a second generating operation for generating a second motion image of the intermediate frame using either the current frame or the previous frame.

The image processing method may further comprise dividing areas of the current frame, the previous frame, and the intermediate frame into a first area and a second area respectively. The image of the intermediate frame may be created using the divided areas of the current frame and the previous frame.

The first generating operation may generate a background image and a motion image with respect to the first area of the intermediate frame, and generate a background and the first motion image with respect to the second area of the intermediate frame. The second generating operation may generate the second motion image with respect to the second area of the intermediate frame.

The first area may be an inner area of the frame, and the second area may be a boundary area of the frame around the inner area.

The second motion image may be generated when the same image as the motion image in the second area of one of the current frame or the previous frame is absent in the first area and the second area of the other frame.

The first generating operation may generate the motion image for the first area of the intermediate frame and the first motion image for the second area of the intermediate frame based on a motion vector of a motion area of the first area, and the second generating operation may generate the second motion image for the second area of the intermediate frame based on a motion vector around the motion area of the second area.

The neighbor area may be adjacent to the motion area of the first area.

The second generation operation may generate the second motion image using the current frame when a direction of the motion vector of the neighbor area is from the first area to the second area, and generate the second motion image using the previous frame when the direction of the motion vector of the neighbor area is from the second area to the first area.

The image processing method may further comprise determining a virtual position of an image in the outside of the previous frame using the current frame when the direction of the motion vector of the neighbor area is from the first area to the second area, and determining a virtual position in the outside of the current frame using the previous frame when the direction of the motion vector of the neighbor area is from the second area to the first area.

The second generation operation may generate the second motion image using the previous frame when the direction of the motion vector of the neighbor area is from the first area to the second area, and generate the second motion image using the current frame when the direction of the motion vector of the neighbor area is from the second area to the first area.

The image processing method may further comprise determining a virtual position of an image in the outside of the current frame using the previous frame when the direction of the motion vector of the neighbor area is from the first area to the second area, and determining a virtual position in the outside of the previous frame using the current frame when the direction of the motion vector of the neighbor area is from the second area to the first area.

The image processing method may further comprise compensating for the generated second motion image by weighting and averaging a bilinear interpolation result using the frame of the determined virtual position and the frame comprising the second motion image in the second area, and the second motion image of the generated intermediate frame.

The first generating operation may generate the background image and the motion image for the first area of the intermediate frame and the background image and the first motion image for the second area of the intermediate frame using a bilinear interpolation.

According to another aspect of the present invention, it is provided an image processing apparatus for creating an image of an intermediate frame with respect to a current frame and a previous frame, comprising an area discriminator which divides areas of the current frame, the previous frame, and the intermediate frame into a first area and a second area respectively; and an image generator which generates a background image and a first motion image of the intermediate frame using the current frame and the previous frame, and generates a second motion image of the intermediate frame using either the current frame or the previous frame.

The image generator may create the image of the intermediate frame using the areas of the current frame and the previous frame, the areas divided by the area discriminator.

The image generator may generate the background image and the motion image for the first area of the intermediate frame using the current frame and the previous frame and generate the background image and the first motion image for the second area of the intermediate frame, and the image generator may generate the second motion image for the second area of the intermediate frame using one of the current frame and the previous frame.

The first area may be an inner area of the frame, and the second area may be a boundary area of the frame around the inner area.

The image generator may generate the second motion image when the same image as the motion image in the second area of one of the current frame and the previous frame is absent in the first area and the second area of the other frame.

The image generator may generate the motion image for the first area of the intermediate frame and the first motion image for the second area of the intermediate frame based on a motion vector of a motion area of the first area, and the image generator may generate the second motion image for the second area of the intermediate frame based on a motion vector around the motion area of the second area.

The neighbor area may be adjacent to the motion area of the first area.

The image generator may generate the second motion image using the current frame when a direction of the motion vector of the neighbor area is from the first area to the second area, and the image generator may generate the second motion image using the previous frame when the direction of the motion vector of the neighbor area is from the second area to the first area.

The image generator may determine a virtual position of an image in the outside of the previous frame using the current frame when the direction of the motion vector of the neighbor area is from the first area to the second area, determine a virtual position in the outside of the current frame using the previous frame when the direction of the motion vector of the neighbor area is from the second area to the first area, and perform a bilinear interpolation using the frame of the virtual position and the frame of the second motion image in the second area.

The image generator may generate the second motion image using the previous frame when the direction of the motion vector of the neighbor area is from the first area to the second area, and the image generator may generate the second motion image using the current frame when the direction of the motion vector of the neighbor area is from the second area to the first area.

The image generator may determine a virtual position of an image in the outside of the current frame using the previous frame when the direction of the motion vector of the neighbor area is from the first area to the second area, determine a virtual position in the outside of the previous frame using the current frame when the direction of the motion vector of the neighbor area is from the second area to the first area, and perform a bilinear interpolation using the frame of the virtual position and the frame of the second motion image in the second area.

The image processing apparatus may further comprise an image compensator which compensates for the generated second motion image by weighting and averaging the image of the bilinear interpolation and the second motion image of the generated intermediate frame.

The image generator may generate the background image and the motion image for the first area of the intermediate frame and the background image and the first motion image for the second area of the intermediate frame using the bilinear interpolation.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 depicts an image output according to a conventional image processing method;

FIG. 2 is a block diagram of an image processing apparatus according to an exemplary embodiment of the present invention;

FIGS. 3A and 3B depict the area division of an image processing apparatus according to an exemplary embodiment of the present invention;

FIGS. 4A, 4B and 4C depict an interpolation according to an exemplary embodiment of the present invention;

FIG. 5 is a flowchart of an image processing method according to another exemplary embodiment of the present invention; and

FIG. 6 is a block diagram of an AV device according to an exemplary embodiment of the present invention.

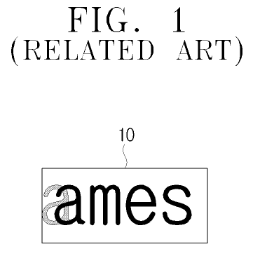

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

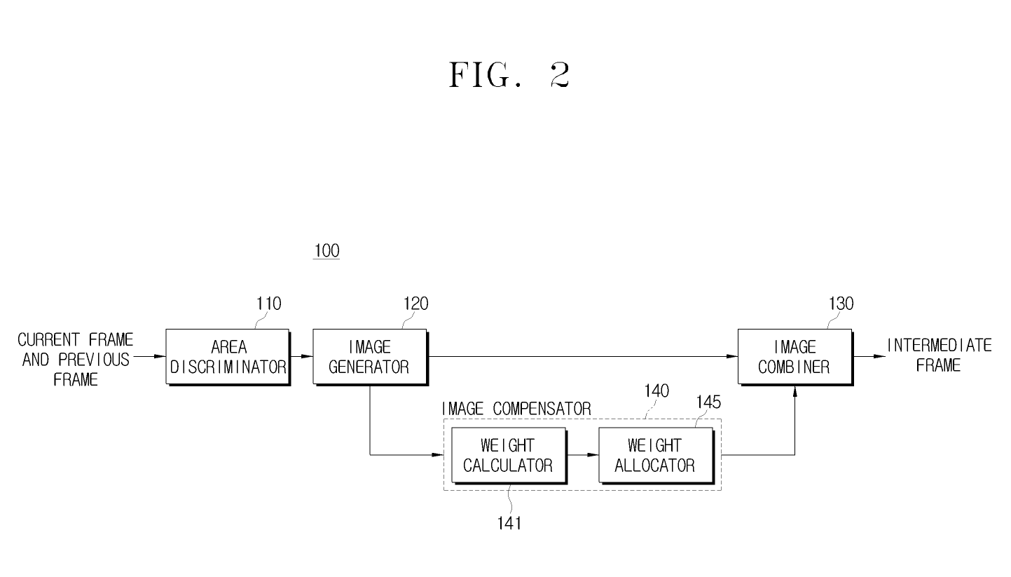

FIG. 2 is a block diagram of an image processing apparatus according to an exemplary embodiment of the present invention. The image processing apparatus 100 comprises an area discriminator 110, an image generator 120, an image combiner 130, and an image compensator 140.

The area discriminator 110 receives a current frame and a previous frame and distinguishes an area of a background image and an area of a motion image in the current frame and the previous frame. In detail, the area discriminator 110 divides the current frame and the previous frame into an inner area and a boundary area, and examines whether the same motion image is in the current frame and the previous frame using the divided area information.

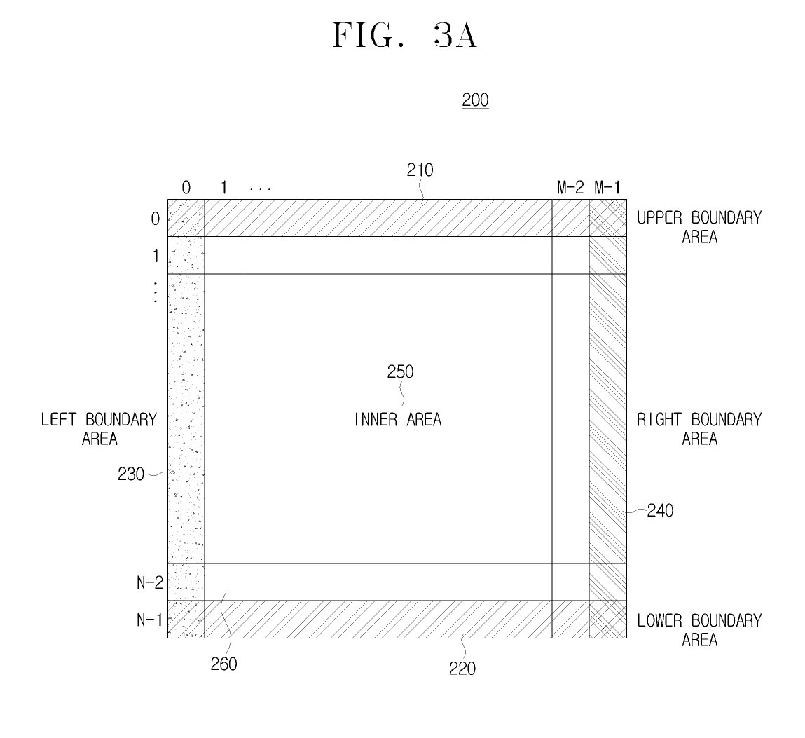

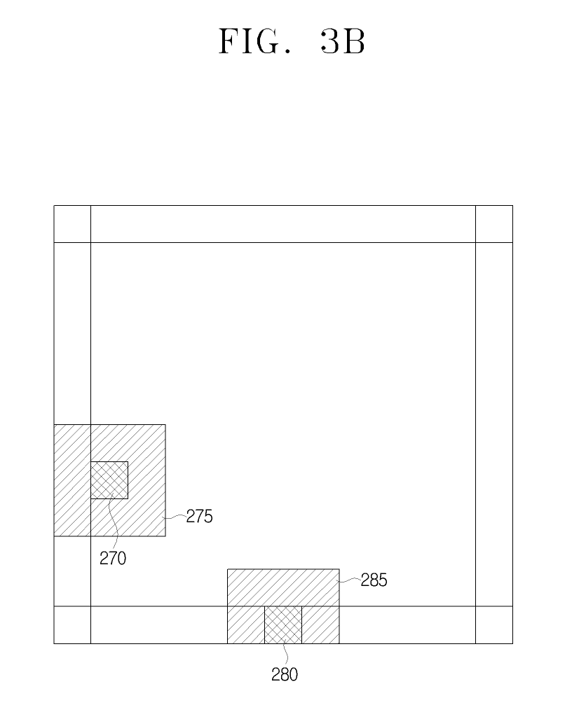

To ease the understanding, the discrimination of the frame areas and the examining whether the same motion image is in the current frame and the previous frame are explained by referring to FIGS. 3A and 3B.

FIGS. 3A and 3B depict the area discrimination of the image processing apparatus.

FIG. 3A illustrates the division of a frame (e.g., the current frame and the previous frame) into the inner area and the boundary area. In FIG. 3A, the frame 200 is divided into the inner area 250 and the boundary area. The boundary area is sub-divided into an upper boundary area 210, a lower boundary area 220, a left boundary area 230, and a right boundary area 240.

In the frame 200, the upper boundary area 210 occupies a 0-th line, the lower boundary area 220 occupies a (N−1)-th line, the left boundary area 230 occupies a 0-th column, and the right boundary area 240 occupies a (M−1)-th column.

The inner area 250 and the upper, lower, left and right boundary areas 210 through 240 of the frame 200 are split into a plurality of blocks 260; that is, into M-ary blocks in the horizontal direction and N-ary blocks in the vertical direction. Hence, the frame is split into M×N blocks in total.

The area discriminator 110 divides the current frame and the previous frame into M×N blocks and sets the inner area and the boundary area. Then, the discriminator 110 examines whether a motion image in a specific block in one of the current frame and the previous frame, is found in the other of the current frame and the previous frame.

FIG. 3B illustrates the detecting of the motion image around a specific block.

In FIG. 3B, neighbor blocks 275 and 285 are surrounding center blocks 270 and 280 respectively. A center block is a block where the motion image is present in the current frame or the previous frame.

To determine whether the same motion image in the current frame is also in the previous frame, or vice versa, the area discriminator 110 inspects areas within the frame 200. For example, when the motion image, i.e., a motion area, is present in block 270 of the inner area of the current frame, the area discriminator 110 sets the block 270 of the inner area as a center block and neighbor blocks 275 around the corresponding center block 270 in the previous frame for the presence of the same motion image.

As for the block 280 in the boundary area, when the motion image is present in the block 280 in one of the previous and the current frame, the area discriminator 110 inspects the neighbor blocks 285 around the corresponding center block 280 in another of the previous and the current frame for the presence of the same motion image. However, when the center block 280 is in the boundary area of the one of the previous and the current frame, the number of neighbor blocks 285 in the other of the previous and the current frame which can be inspected is limited because it is impossible to inspect some of the neighboring blocks that are not in the other of the previous and the current frame.

Referring back to FIG. 2, the area discriminator 110 divides the current frame and the previous frame into the inner area and the boundary area, examines whether the same motion image in one of the current frame and the previous frame is also present in the other of the current frame and the previous frame using the divided area information, i.e., the information in each of the divided areas, and outputs the area information to the image generator 120.

The image generator 120 generates an intermediate frame using the area information output from the area discriminator 110. Specifically, the image generator 120 generates a background image and the motion image in the intermediate frame by receiving the current frame and the previous frame. In an exemplary embodiment, the image generator 120 may generate a background image and a motion image in an inner area of the intermediate frame and may generate a motion image in a boundary area of the intermediate frame.

The background image indicates a static image that is at the same position in both the current frame and the previous frame, and the motion image is not present at the same positions in both the current frame and the previous frame.

The motion image can be classified into two types. One type of motion image is a type where the motion image is present in the inner area or the boundary area in both of the current frame and the previous frame, but at different positions. Another type is a type where the motion image is present in the boundary area of one of the current frame and the previous frame and the same motion image is not present in the inner area and the boundary area in the other of the current frame and the previous frame.

For example, referring to FIG. 3B, when the motion image of one of the current frame and the previous frame is present in the center block 280 of the boundary area and the motion image is not present in the other of the current frame and the previous frame because the motion image may be present outside the other of the current and the previous frames.

When the background image is generated and the motion image is present in both the current frame and the previous frame, the image generator 120 creates the motion image in the intermediate frame through a bilinear interpolation using a vector indicative of the position of the motion image in the current frame, a vector indicative of the position of the motion image in the previous frame, and a motion vector indicative of the change or the difference in positions of the motion image in the current and the previous frames.

The bilinear interpolation is expressed as follows:

$${f}_{n}^{′} ( \vec{X} ) = \frac{1}{2} [ {f}_{n} ( {\vec{X}}_{n} - \frac{\vec{V}}{2} ) + {f}_{n - 1} ( {\vec{X}}_{n - 1} + \frac{\vec{V}}{2} ) ] \qquad [ Equation 1 ]$$

In Equation 1, \vec{X}′, \vec{X}ₙ₋₁ and \vec{X}ₙ are position vectors of the motion image in the intermediate frame, the motion image in the previous frame and the motion image in the current frame, and \vec{V} is a motion vector indicative of the change in position between the motion image position in the current frame and the motion image position in the previous frame. ƒₙ′ is a function indicative of the intermediate frame, ƒₙ is a function indicative of the current frame, and ƒₙ₋₁ is a function indicative of the previous frame.

Ultimately, the image generator 120 generates the motion image in the intermediate frame using the bilinear interpolation which averages the value acquired by subtracting the half of the motion vector from the motion image position in the current frame and the value acquired by adding the half of the motion vector to the motion image position in the previous frame.

By contrast, if the motion image is present in the boundary area of one of the current frame and the previous frame and the same motion image is not in the inner area and the boundary area of the other of the current frame and the previous frame, the motion image cannot be created in the intermediate frame through the bilinear interpolation because one of the two positions of the motion image necessary to perform bilinear interpolation does not exist.

Thus, the image generator 120 generates the motion image in the intermediate frame using only one of the current frame and the previous frame, which has the motion image.

When the motion image is present in the previous frame and the same motion image is not present in the current frame, the image generator 120 creates the motion image in the intermediate frame through a forward interpolation using the motion vector of another image in the inner area most adjacent to the motion image in the previous frame. In an exemplary embodiment, the other image may be a neighboring image.

In other words, since the position of the motion image in the current frame is not known, the motion vector of the motion image estimated by using the motion vector of the other image from the current frame to the previous frame.

This forward interpolation is expressed as follows:

$${f}^{′} ( {\vec{X}}^{′} ) = {f}_{n - 1} ( {\vec{X}}_{n - 1} + \frac{\vec{V}}{2} ) \qquad [ Equation 2 ]$$

In Equation 2, \vec{V} is a motion vector of the another image in the inner area most adjacent to the motion image in the previous frame.

When the motion image is present in the current frame and the motion image is not present in the previous frame, the image generator 120 creates the motion image in the intermediate frame through a backward interpolation using the motion vector of another image in the inner area most adjacent to the motion image in the current frame.

This backward interpolation is expressed as follows:

$${f}^{′} ( {\vec{X}}^{′} ) = {f}_{n} ( {\vec{X}}_{n} - \frac{\vec{V}}{2} ) \qquad [ Equation 3 ]$$

In Equation 3, \vec{V} is a motion vector of the other image in the inner area most adjacent to the motion image in the current frame.

As such, when the motion image is present in the current frame and the same motion image is absent in the previous frame, the image generator 120 creates the motion image in the intermediate frame through a backward interpolation using the motion image in the current frame.

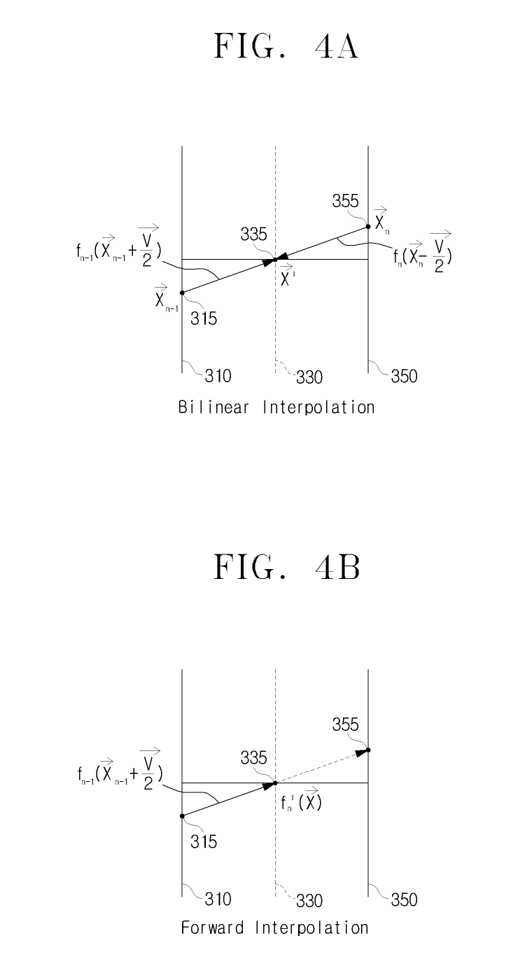

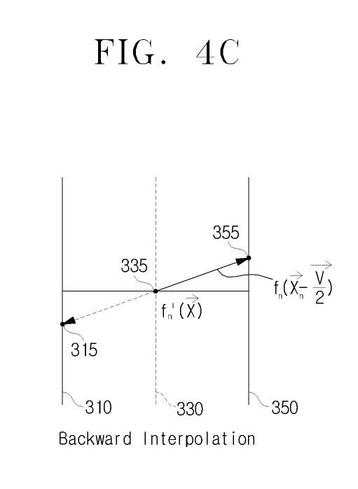

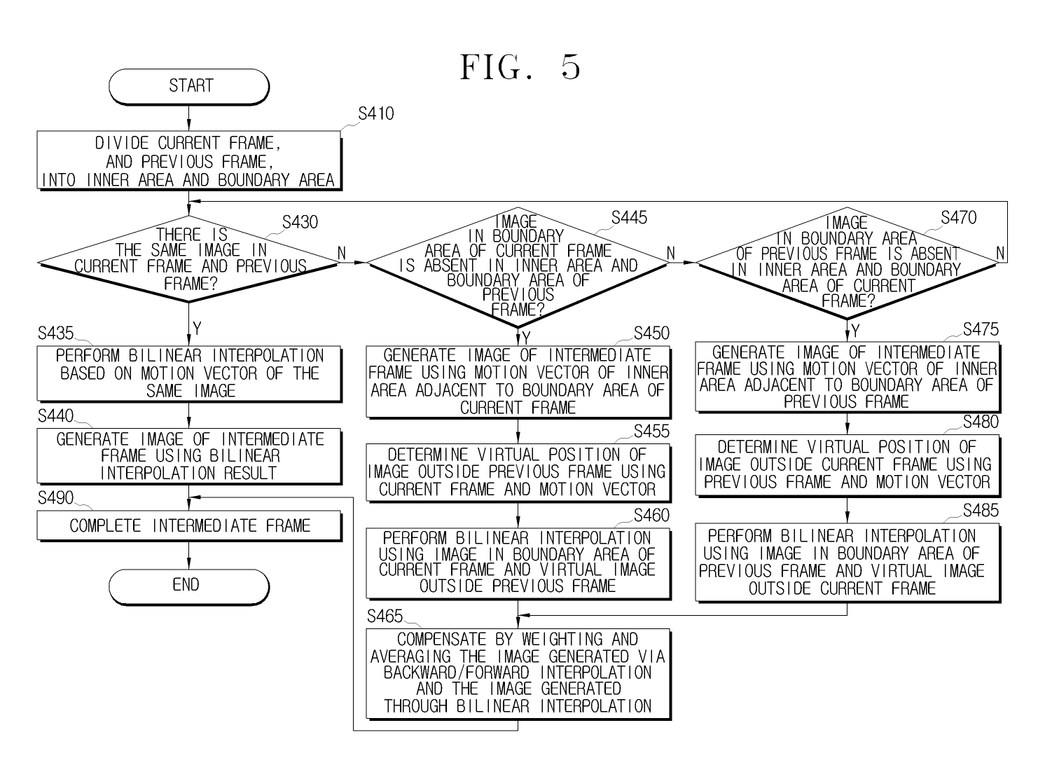

Hereafter, the bilinear interpolation, backward interpolation, and the forward interpolation are further explained by referring to FIGS. 4A, 4B and 4C.

FIGS. 4A, 4B and 4C depict the interpolations.

FIG. 4A illustrates the bilinear interpolation in view of the previous frame 310, the intermediate frame 330, and the current frame 350.

When the background image of the intermediate frame is generated and when the motion image in the intermediate frame is generated for the case where the motion image is present in both of the current frame and the previous frame, the image generator 120 creates the motion image in the intermediate frame 330 through the bilinear interpolation using the previous frame 310 and the current frame 350. Specifically, the image generator 120 creates the motion image in the intermediate frame 330 by placing the motion image 335 in the intermediate frame 330 through the bilinear interpolation using the position vectors \vec{X}, \vec{X}ₙ₋₁ and \vec{X}ₙ of the motion image in the respective intermediate, previous and current frames and the motion vector \vec{V} which uses the difference in position between the motion image position 315 in the previous frame 310 and the motion image position 355 in the current frame 350.

FIG. 4B illustrates the forward interpolation. When the motion image is present in the boundary area of the previous frame 310 and the same motion image is absent in the inner area and the boundary area of the current frame 350, the image generator 120 creates the motion image 335 in the intermediate frame 330 through forward interpolation by estimating the position of the motion image 335 in the intermediate frame 330 through using the previous frame 310. Specifically, the image generator 120 creates the motion image 335 in the intermediate frame 330 through forward interpolation using the position vector of the motion image 315 in the previous frame 310 and the motion vector of the other image in the inner area most adjacent to the motion image 315 in the boundary area of the previous frame 310.

FIG. 4C illustrates the backward interpolation. When the motion image 355 is present in the boundary area of the current frame 350 and the same motion image is not present in the inner area and the boundary area of the previous frame 310, the image generator 120 creates the motion image 335 in the intermediate frame 330 through backward interpolation using the current frame 350. Specifically, the image generator 120 creates the motion image 335 in the intermediate frame 330 through the backward interpolation using the position vector of motion image 355 in the current frame 350 and the motion vector of the other image in the inner area most adjacent to the motion image 355 in the boundary area of the current frame 350.

Referring back to FIG. 2, the image generator 120 provides the generated images to the image combiner 130 and the image compensator 140.

When the background image of the intermediate frame is generated or when a motion image in both of the current frame and the previous frame is present in the inner area or the boundary area, the image generator 120 generates a motion image in the intermediate frame and provides the generated motion image to the image combiner 130. Additionally, when the motion image is present in the boundary area of the current frame and the motion image is absent in the boundary area or the inner area of the previous frame or when the motion image is present in the boundary area of the previous frame and the motion image is absent in the boundary area or the inner area of the current frame, the image generator 120 provides the motion image present in the boundary area of the current frame or in the boundary area of the previous frame to the image compensator 140.

The image compensator 140 uses the information relating to the position vector of the motion image in the intermediate frame and the motion vector indicative of the change in position of the motion image between the current frame and the previous frame, which are used at the image generator 120.

The image compensator 140 compensates for the motion images created in the intermediate frame using the information relating to the motion images generated at the image generator 120.

The image compensator 140 operates when the motion image is present in the boundary area of the current frame and the same motion image is absent in the boundary area or the inner area of the previous frame or when the motion image is present in the boundary area of the previous frame and the same motion image is absent in the boundary area or the inner area of the current frame.

For example, when the motion image is present in the boundary area of the current frame and the same motion image is absent in the boundary area or the inner area of the previous frame, the image compensator 140 creates the virtual position of the motion image in the outer area of the previous frame using the position vector of the motion image in the current frame and the motion vector of the other image in the inner area most adjacent to the boundary area of the current frame. Then the image compensator 140 bi-linearly interpolates using the virtual position of the motion image in the previous frame and the position of the motion image in the current frame. The bilinear interpolation using the virtual position of the motion image in the previous frame generates the position vector of the same motion image in the intermediate frame.

Next, the image compensator 140 weights and averages the motion image generated using the bilinear interpolation and the motion image generated using the backward interpolation at the image generator 120.

Likewise, when the motion image is present in the boundary area of the previous frame and the same motion image is absent in the boundary area or the inner area of the current frame, the image compensator 140 weights and averages the motion image generated through the bilinear interpolation and the motion image generated through the forward interpolation at the image generator 120.

The image compensator 140 comprises a weight calculator 141 and a weight allocator 145.

The weight calculator 141 calculates weights to be applied to the motion image generated through the bilinear interpolation and the motion image generated through the backward or forward interpolation.

After calculating the weights, the weight calculator 141 outputs the weights to the weight allocator 145.

The weight allocator 145 applies the weights received from the weight calculator 141 to the motion image generated through the bilinear interpolation and the motion image generated through the backward or the forward interpolation respectively.

When the motion image is present in the boundary area of the previous frame and the same motion image is not present in the boundary area or the inner area of the current frame, the weights for the motion image generated through the bilinear interpolation and the motion image generated through the forward interpolation are calculated as follows:

$${f}_{n}^{′} ( \vec{X} ) = w \cdot \frac{1}{2} [ {f}_{n - 1} ( {\vec{X}}_{n - 1} + \frac{\vec{V}}{2} ) + {f}_{n} ( {\vec{X}}_{n}^{*} - \frac{\vec{V}}{2} ) ] + ( 1 - w ) \cdot {f}_{n - 1} ( {\vec{X}}_{n - 1} + \frac{\vec{V}}{2} ) \qquad [ Equation 4 ]$$

In Equation 4, the former term denotes the result value of the bilinear interpolation, the latter term denotes the result value of the forward interpolation, and w denotes the weight. Further, \vec{X}*ₙ denotes the virtual position of the motion image in the current frame.

Likewise, when the motion image is present in the boundary area of the current frame and the same motion image is not present in the boundary area or the inner area of the previous frame, the weights for the motion image generated through the bilinear interpolation and the motion image generated through the backward interpolation are calculated as follows:

$${f}_{n}^{′} ( \vec{X} ) = w \cdot \frac{1}{2} [ {f}_{n - 1} ( {\vec{X}}_{n - 1}^{*} + \frac{\vec{V}}{2} ) + {f}_{n} ( {\vec{X}}_{n} - \frac{\vec{V}}{2} ) ] + ( 1 - w ) \cdot {f}_{n} ( {\vec{X}}_{n} - \frac{\vec{V}}{2} ) \qquad [ Equation 5 ]$$

In Equation 5, the former term denotes the result value of the bilinear interpolation, the latter term denotes the result value of the backward interpolation, and w denotes the weight. Further, \vec{X}*ₙ₋₁ denotes the virtual position of the motion image in the previous frame.

The weight w is a function of the matching error ε. The weight w and the matching error are defined as follows:

$$w ( ɛ ) = \{ \begin{matrix}{y}_{max} & ( ɛ \leq {x}_{min} ) \\ \frac{{y}_{min} - {y}_{max}}{{x}_{max} - {x}_{min}} ( ɛ - {x}_{min} ) + {y}_{max} & ( {x}_{min} < ɛ \leq {x}_{max} ) \\ {y}_{min} & ( ɛ > {x}_{max} )\end{matrix} \\ ɛ ( \vec{x} ) = {\sum }_{\vec{d} ∈ {S}_{near}} \vert {f}_{n - 1} ( \vec{x} + \frac{\vec{v}}{2} + \vec{d} ) - {f}_{n} ( \vec{x} - \frac{\vec{v}}{2} + \vec{d} ) \vert \qquad [ Equation 6 ]$$

In Equation 6, x is a x-direction component, y is a y-direction component, xₘᵢₙ is a minimum value of x, yₘᵢₙ is a minimum value of y, xₘₐₓ is a maximum value of x, and yₘₐₓ is a maximum value of y.

Sₙₑₐᵣ denotes a set of motion vectors \vec{d} of the neighbor areas, which is {(−1, −1), (−1, 0), (−1, 1), (0, −1), (0, 1), (1, −1), (1, 0), (1, 1)}.

As such, the weight allocator 145 applies the weights to the results of the bilinear interpolation and the forward or backward interpolation, and outputs the weighted image to the image combiner 130.

The image combiner 130 completes the intermediate frame by combining the motion images output from the image generator 120 and the image compensator 140.

In more detail, the image combiner 130 receives from the image generator 120 the image generated when the background image is generated in the intermediate frame and the motion image is generated if the motion image is present in the inner area or the boundary area in both of the current frame and the previous frame, and receives from the image compensator 140 the image generated when the motion image is present in the boundary area of the current frame and the same motion image is absent in boundary area or the inner area of the previous frame or when the motion image is present in the boundary area of the previous frame and the same motion image is absent in the boundary area or the inner area of the current frame, and then combines the received images.

FIG. 5 is a flowchart of an image processing method according to another exemplary embodiment of the present invention.

Referring to FIG. 5, the area discriminator 110 divides the current frame and the previous frame into the inner area and the boundary area (S410).

When the area division is completed, the area discriminator 110 examines whether the same motion image is in the current frame and the previous frame using the divided area information (S430).

If the same motion image is in the current frame and the previous frame (S430-Y), the image generator 120 performs the bilinear interpolation based on the motion vector of the same motion image (S435) and creates the motion image in the intermediate frame using the result of the bilinear interpolation (S440).

If the same motion image is not present in the current frame and the previous frame (S430-N), the area discriminator 110 examines whether a motion image in the boundary area of the current frame is absent in the inner area and the boundary area of the previous frame (S445).

If the motion image in a boundary area of the current frame is absent in the inner area and the boundary area of the previous frame (S445-Y), the image generator 120 creates the motion image in the intermediate frame using the motion vector of another image in the inner area of the current frame most adjacent to the motion image in the boundary area of the current frame (S450), through backward interpolation.

When the motion image in the intermediate frame is created at the image generator 120, the image compensator 140 determines the virtual position of the motion image at the outside of the previous frame using the current frame and the motion vector of the other image.

In doing so, the image compensator 140 determines the virtual position of the motion image at the outside of the previous frame using the position vector of the motion image in the current frame and the motion vector of the other image in the inner area of the current frame most adjacent to the motion image in the boundary area of the current frame which are used at the image generator 120 (S455).

Next, the image compensator 140 performs the bilinear interpolation using the motion image in the boundary area of the current frame and the virtual motion image outside of the previous frame (S460).

The image compensator 140 compensates by weighting and averaging the motion image of intermediate frame created through backward interpolation and the motion image in the intermediate frame created through the bilinear interpolation (S465).

When the motion image in the boundary area of the current frame is not absent in the inner area and the boundary area of the previous frame (S445-N), the area discriminator 110 examines whether the motion image in the boundary area of the previous frame is absent in the inner area and the boundary area of the current frame (S470).

When the motion image in the boundary area of the previous frame is absent in the inner area and the boundary area of the current frame (S470-Y), the image generator 120 creates the motion image in the intermediate frame using the motion vector of another image in the inner area of the previous frame most adjacent to the motion image in the boundary area of the previous frame (S475).

After the image generator 120 creates the motion image in the intermediate frame using forward interpolation, the image compensator 140 determines the virtual position of the motion image outside the current frame using the previous frame and the motion vector of the other image.

In doing so, the image compensator 140 determines the virtual position of the motion image outside the current frame using the position vector of the motion image in the previous frame and the motion vector of the other image in the inner area of the previous frame most adjacent to the motion image in the boundary area of the previous frame, which are used at the image generator 120 (S480).

Next, the image compensator 140 performs the bilinear interpolation using the motion image in the boundary area of the previous frame and the virtual motion image outside the current frame (S485).

Upon completing the bilinear interpolation, the image compensator 140 compensates by weighting and averaging the motion image in the intermediate frame generated through the forward interpolation and the motion image in the intermediate frame generated through the bilinear interpolation (S465).

Next, the image compensator 140 outputs the compensated images to the image combiner 130 and the image combiner 130 completes the intermediate frame by combining the motion image received from the image generator 120 and the compensated motion image received from the image compensator 140 (S490).

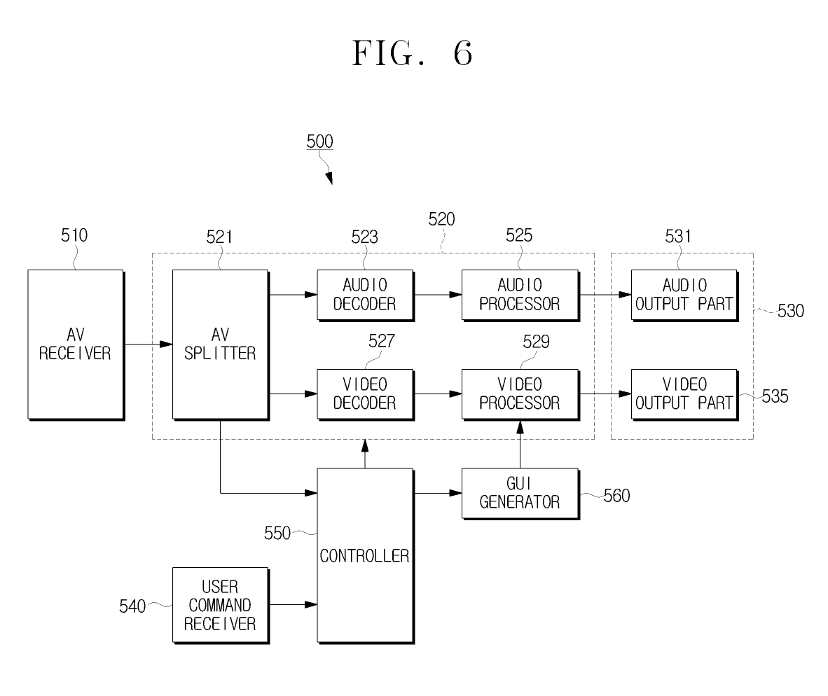

FIG. 6 is a block diagram of an AV device according to an exemplary embodiment of the present invention. The AV device 500 of FIG. 6 comprises an AV receiver 510, an AV processor 520, an AV output part 530, a user command receiver 540, a controller 550, and a graphical user interface (GUI) generator 560.

The AV receiver 510 receives an AV signal from an external device. The AV processor 520 processes the AV signal received at the AV receiver 510.

The AV processor 520 comprises an AV splitter 521, an audio decoder 523, an audio processor 525, a video decoder 527, and a video processor 529.

The AV splitter 521 splits the AV signal output from the AV receiver 510 to an audio signal and a video signal.

The audio decoder 523 decodes the audio signal output from the AV splitter 521. The audio processor 525 processes the decoded audio data output from the audio decoder 523.

The video decoder 527 decodes the video signal output from the AV splitter 521. The video processor 529 processes the decoded video signal output from the video decoder 527.

The GUI generator 560 generates a GUI to be displayed in a display. The GUI generated at the GUI generator 560 is applied to the video processor 529 and added to the video to be displayed.

The output part 530 comprises an audio output part 531 and a video output part 535. The audio output part 531 outputs the audio signal fed from the audio processor 525 through a speaker. The video output part 535 outputs the video signal fed from the video processor 529 through the display.

The user command receiver 540 forwards a user command received from a remote controller to the controller 550. The controller 550 controls the overall operation of the DTV—the AV device 500 according to the user command fed from the user command receiver 540.

The video processor 529 can be implemented using the image processing apparatus as described above.

So far, to facilitate understanding, it is assumed that the image compensator 140 compensates for the result of the backward interpolation or the forward interpolation using the bilinear interpolation when the motion image is present in the boundary area of the current frame and the same motion image is absent in the boundary area or the inner area of the previous frame or when the motion image is present in the boundary area of the previous frame and the same motion image is absent in the boundary area or the inner area of the current frame. Note that the intermediate frame can be created merely through the backward interpolation or the forward interpolation without the operations of the image compensator 140.

Also, the frame is divided into M×N blocks, the upper boundary area 210 occupies the 0-th line, the lower boundary area 220 occupies the (N−1)-th line, the left boundary area 230 occupies the 0-th column, and the right boundary area 240 occupies the (M−1)-th column by way of example. Note that the frame can be divided into a different number of blocks to change the block size, and that the respective boundary areas can be variously defined.

As described above, according to the exemplary embodiments of the present invention, it is possible to minimize interpolation error in the boundary of a frame where a motion estimation error is highly likely to occur, so that the quality of an interpolated image may be improved to satisfy user's desire to view accurate image in a boundary.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image processing method comprising:
forming an image of an intermediate frame based on at least one of a current frame and a previous frame, the forming comprising at least one of:
first generating a background image and a first motion image of the intermediate frame based on the current frame and the previous frame; and
second generating a second motion image of the intermediate frame based on one of the current frame and the previous frame.

2. The image processing method of claim 1, further comprising:
dividing the current frame into a first area of the current frame and a second area of the current frame, and the previous frame into a first area of the previous frame and a second area of the previous frame,
wherein the intermediate frame is generated based on the divided current frame and the divided previous frame, and
the intermediate frame comprises a first area of the intermediate frame and a second area of the intermediate frame, which respectively correspond to the first and the second areas of the current frame, and which respectively correspond to the first and the second areas of the previous frame.

3. The image processing method of claim 2, wherein the first generating generates a background image in the first area of the intermediate frame and a motion image in the first area of the intermediate frame, and generates a background image in the second area of the intermediate frame and a motion image in the second area of the intermediate frame; and
the second generating generates the second motion image in the second area of the intermediate frame.

4. The image processing method of claim 2, wherein the first areas of the previous frame, the intermediate frame and the current frame are inner areas of the respective previous, intermediate and current frames, and
the second areas of the previous frame, the intermediate frame and the current frame are boundary areas of the respective previous, intermediate and current frames, which are disposed around the respective inner areas of the previous frame, the intermediate frame and the current frame.

5. The image processing method of claim 2, wherein the second motion image is generated if a motion image in the second area of one of the current frame and the previous frame is absent in the other of the current frame and the previous frame.

6. The image processing method of claim 3, wherein the first generating generates the motion image in the first area of the intermediate frame and the motion image in the second area of the intermediate frame based on a motion vector of a motion area in the first area of one of the current and the previous frames, and
the second generating operation generates the second motion image in the second area of the intermediate frame based on a motion vector of a neighboring area near a motion area in the second area of the one of the current and the previous frames.

7. The image processing method of claim 6, wherein the neighboring area is adjacent to the motion area and in the first area of the one of the current and the previous frames.

8. The image processing method of claim 7, wherein the second generating generates the second motion image based on the current frame if a direction of the motion vector of the neighboring area is from the first area of the current frame to the second area of the previous frame, and generates the second motion image based on the previous frame if the direction of the motion vector of the neighboring area is from the first area of the previous frame to the second area of the current frame.

9. The image processing method of claim 8, further comprising:
determining a virtual position of a motion image at the outside of the previous frame based on the current frame if the direction of the motion vector of the neighboring area is from the first area of the current frame to the second area of the previous frame, and determining a virtual position at the outside of the current frame based on the previous frame if the direction of the motion vector of the neighboring area is from the first area of the previous frame to the second area of the current frame.

10. The image processing method of claim 9, further comprising:
compensating the generated second motion image by weighting and averaging a bilinear interpolation result based on the determined virtual position and the motion area in the second area, and the second motion image of the generated intermediate frame.

11. The image processing method of claim 2, wherein the first generating generates the background image and the motion image in the first area of the intermediate frame and the background image and the motion image in the second area of the intermediate frame based on a bilinear interpolation.

12. An image processing apparatus for creating an image of an intermediate frame based on at least one of a current frame and a previous frame, comprising:
an area discriminator which divides the current frame into a first area of the current frame and a second area of the current frame, and divides the previous frame into a first area of the previous frame and a second area of the previous frame; and
an image generator which generates a background image and a first motion image of the intermediate frame based on the current frame and the previous frame, or generates a second motion image of the intermediate frame based on one of the current frame and the previous frame,
wherein the intermediate frame comprises a first area of the intermediate frame and a second area of the intermediate frame, which respectively correspond to the first and the second areas of the current frame, and which respectively correspond to the first and the second areas of the previous frame.

13. The image processing apparatus of claim 12, wherein the image generator generates the intermediate frame based on the divided current frame and the divided previous frame.

14. The image processing apparatus of claim 13, wherein the image generator generates a background image in the first area of the intermediate frame and a motion image in the first area of the intermediate frame based on the current frame and the previous frame and generates a background image in the second area of the intermediate frame and a motion image in the second area of the intermediate frame, and
the image generator generates the second motion image in the second area of the intermediate frame based on one of the current frame and the previous frame.

15. The image processing apparatus of claim 13, wherein the first areas of the previous frame, the intermediate frame and the current frame are inner areas of the respective previous, intermediate and current frames, and
the second areas of the previous frame, the intermediate frame and the current frame are boundary areas of the respective previous, intermediate and current frames, which are disposed around the respective inner areas of the previous frame, the intermediate frame and the current frame.

16. The image processing apparatus of claim 13, wherein the image generator generates the second motion image if a motion image in the second area of one of the current frame and the previous frame is absent in the another of the current frame and the previous frame.

17. The image processing apparatus of claim 14, wherein the image generator generates the motion image in the first area of the intermediate frame and the motion image in the second area of the intermediate frame based on a motion vector of a motion area in the first area in one of the current and the previous frames, and
the image generator generates the second motion image in the second area of the intermediate frame based on a motion vector of a neighboring area near a motion area in the first area of one of the current and the previous frames.

18. The image processing apparatus of claim 17, wherein the neighboring area is adjacent to the motion area and in the first area of the one of the current and the previous frames.

19. The image processing apparatus of claim 18, wherein the image generator generates the second motion image based on the current frame if a direction of the motion vector of the neighboring area is from the first area of the current frame to the second area of the previous frame, and
the image generator generates the second motion image based on the previous frame if the direction of the motion vector of the neighboring area is from the first area of the previous frame to the second area of the current frame.

20. The image processing apparatus of claim 19, wherein the image generator determines a virtual position of a motion image outside of the previous frame based on the current frame if the direction of the motion vector of the neighboring area is from the first area of the current frame to the second area of the previous frame, determines a virtual position at the outside of the current frame based on the previous frame if the direction of the motion vector of the neighboring area is from the first area of the previous frame to the second area of the current frame, and performs a bilinear interpolation based on the virtual position and the motion area in the second area to generate an image of the bilinear interpolation.

21. The image processing apparatus of claim 20, further comprising:
an image compensator which compensates the generated second motion image by weighting and averaging the image of the bilinear interpolation and the second motion image of the generated intermediate frame.

22. The image processing apparatus of claim 13, wherein the image generator generates the background image and the motion image in the first area of the intermediate frame and the background image and the motion image in the second area of the intermediate frame based on the bilinear interpolation.
